(19) United States
(12) Patent Application Publication
(10) Pub. No.: US 2014/0329015 A1
(43) Pub. Date: Nov. 6, 2014

(54) PEELABLE ANTIFOG COATED FILM FOR AMORPHOUS POLYESTER TRAYS

(71) Applicant: TORAY PLASTICS (AMERICA), INC., N. Kingstown, RI (US)

(72) Inventors: Jon Ian MONTCRIEFF, Foxborough, MA (US); Roberto SIU, Providence, RI (US)

(21) Appl. No.: 14/299,964

(22) Filed: Jun. 9, 2014

Related U.S. Application Data
(62) Division of application No. 13/715,643, filed on Dec. 14, 2012.
(60) Provisional application No. 61/603,788, filed on Feb. 27, 2012.

(51) Int. Cl. B29C 47/00; B29C 37/00; B29C 47/06

(52) U.S. Cl. CPC B29C 47/0004; B29C 47/065; B29C 37/0025; B29K 2067/00
USPC 427/322

(57) ABSTRACT

Described are antifog films useful for packaging food, and more particularly to antifog films that can be used as lidding films in trays made of amorphous polyester. The films may include at least one base layer or film, such as a polyester film, and a heat seal layer. The antifog layer is coated on the heat seal layer. The heat seal layer allows the antifog coating to more strongly adhere to the antifog film. The heat seal layer may be an amorphous polyester layer.

### CROSS-REFERENCE TO RELATED APPLICATION

This application is a divisional of U.S. patent application Ser. No. 13/715,643, filed on Dec. 14, 2012, which claims the benefit of U.S. Provisional Application No. 61/603,788, filed Feb. 27, 2012, the entire contents of which are incorporated herein by reference.

### FIELD OF THE INVENTION

The present invention relates to antifog films useful for packaging food, and more particularly to antifog films that can be used as lidding films in trays made of amorphous polyester (APET).

### BACKGROUND OF THE INVENTION

When a food product containing water is packed in a tray and displayed at a store front or the like at low temperature with a surface of the tray wrapped with a plastic film, fog can grow on the plastic film on the side facing the food product. This is particularly the case when the food product has a high water content. The fog on the inner surface of the wrapping film facing the food product results from the aggregation of tiny water vapors. Invisibility of the contents of the wrapped products through the wrapping film is disfavored by consumers. Accordingly, various attempts have been proposed to prevent fog generation on a plastic film on the side facing a food product.

A refrigerated food tray will have a perimeter lip extending above the stored food item so that the plastic film covering the top of the tray does not touch most of the packaged food. In this arrangement, the consumer may see clearly through the plastic wrap to view the food item stored in the package.

There have been several approaches to reduce fogging. One approach involves dispersing one or more antifog agents in the plastic film resin during processing of the film. Once in the film resin, the antifog agent tends to migrate to the surface of the film and raise the surface tension of the film. As a result, water on the inner side of the film tends to form a relatively continuous film-like, transparent sheet of water rather than a fog.

Another approach to minimize the negative effects of fogging on a film involves applying an antifog coating directly to the plastic film's inner, food-side surface. Although this approach adds the expense of an additional coating step, it provides the benefit of applying the antifog agent to the film surface where it is most effective at reducing fogging.

Japanese Patent Application Publication No. 2002-240214 proposes a sealant film having an excellent antifogging property in which a ketonic compound layer of an ethylene-vinyl acetate copolymer and/or a polyamide-based resin layer are laminated in accordance with a co-extrusion method on one surface of a polyolefin-based resin layer containing an antifog agent with a modified polyolefin-based resin layer interposed in between.

U.S. Pat. No. 6,677,014 proposes a plastic antifogging film having a first side and a second side in which at least the first side of the antifogging film has an antifogging property and at least part of the second side has a printed image, the printed image being formed of an effective amount of cellulose acetyl propionate, including an average propionyl content of about 35 wt % to 55 wt %, an average acetyl content of about 0.3 wt % to 3 wt %, and an average hydroxyl content of about 1 wt % to 10 wt % on the basis of the cellulose acetyl propionate; i.e., the use of printing ink containing specific components.

Although these techniques exert an antifogging effect to some extent, there is a demand for more effective antifogging techniques.

### SUMMARY OF THE INVENTION

The present invention tackles one problem that has not been widely addressed before. Traditional lidding films that have been used as lidstock to amorphous polyester trays, usually do not provide antifog and peelable properties.

The peelable, antifog coated film of the present invention presents several advantages. The film provides a protective covering for a refrigerated packaged food item—for example, a refrigerated fruit or vegetable on a tray—yet provide the consumer a pleasing, clear view of the stored food product without the disruption of a ghost condensate image. The peelable properties of the lidding film allow for easy opening of the cover film without the need to tear or cut the film open.

Most APET (amorphous polyethylene terephthalate) trays rely on silicone release coatings (or denesting coatings) to be able to release from each other when they are stacked together. This coating creates a major problem as it creates a thin layer of lubricated material that is difficult to seal through.

Embodiments of a multilayer antifog film may include a base layer a heat seal layer; and an antifog layer coated on the heat seal layer. The heat seal layer allows the antifog layer to adhere to the antifog film. The base layer may comprise or consist of polyester. The heat seal layer may include amorphous polyester and may provide peelable seals to amorphous polyester trays. In some embodiments, the heat seal layer has a thickness of about 0.01 to 2 mils. In some embodiments, the thickness of the heat seal layer is from 0.025 to 50 percent of the thickness of the multilayer film.

In some embodiments, the antifog layer is a coating applied in the range of about 1 to 10 gram/sq meter, more preferably in the range of about 2 to 6 grams per square meter.

Preferably, the film has a seal strength to amorphous polyester trays in the range of 400 gm/in to 2,000 gm/in, measured at 275 degrees F., 40 psi, 0.5 seconds, more preferably in the range of 500 gm/in to 1,000 gm/in.

In some embodiments, the film may further include one or more barrier layers, a colored layer comprising ink, and/or a metalized layer. The colored layer could be a printed design, most commonly done by flexographic or rotogravure methods, although any type of printing method could be used. The metalized layer could be applied in a vacuum metalized chamber, commonly known to manufacture metalized films for commodity industries like snack packaging or balloon film. This layer is most commonly comprised of vacuum deposited aluminum at levels of optical density in the 1.0 to 3.0 range, but levels outside this range are possible as well.

Embodiments of a method of making a multilayer antifog film may include coextruding a base layer including polyester and a heat seal layer comprising amorphous copolyester; and applying an antifog coating on a surface of the heat seal layer.

The method may further include biaxially orienting the base layer. For example, the base layer may be oriented 2 to 6 times in a longitudinal dimension and 2 to 5 times in a transverse dimension. One or more barrier layers may be co-extruded with the base layer and heat seal layer.

Embodiments of a sealed amorphous polyester tray may include an amorphous polyester tray, and a sealing film including a base layer, a heat seal layer including amorphous polyester, and an antifog layer coated on the heat seal layer.

### BRIEF DESCRIPTION OF THE DRAWINGS

The novel features which are characteristic of the present invention are set forth in the appended claims and examples. However, the invention's preferred embodiments, together with further objects and attendant advantages, will be best understood by reference to the following detailed description and Examples taken in connection with the accompanying figure in which:

FIG. 1 shows antifog pictures for the Examples and Comparative Examples after 120 minutes of refrigeration.

### DETAILED DESCRIPTION OF THE INVENTION

Described are antifog films useful for packaging food, and more particularly to antifog films that can be used as lidding films in trays made of amorphous polyester (APET). The films may include at least one base layer or film, such as a polyester film, and a heat seal layer. The antifog layer is coated on the heat seal layer. The heat seal layer allows the antifog coating to more strongly adhere to the antifog film. The heat seal layer may be an amorphous polyester layer.

In some embodiments, the multilayered antifog film may include one or more of each of the following layers: i) a food-side or inside layer, ii) a non-food or outside layer, iii) a gas barrier layer, iv) a tie layer, v) an abuse layer, and vi) a bulk layer. The food-side layer may be a heat seal layer with an antifog coating layer applied thereon. The outside/non-food side layer may be a print layer.

Preferably, the antifog coated film is clear so that the packaged item is visible through the film. “Clear” as used herein means that the material transmits incident light with negligible scattering and little absorption, enabling objects (e.g., packaged food or print) to be seen clearly through the material under typical viewing conditions (i.e., the expected use conditions of the material).

### Base Film

The base film may include any plastic material, such as a thermoplastic, that is suitable for packaging food products. Useful plastics include homopolymers, copolymers, terpolymers, and heteropolymers of one or more of polyolefins, polyamides, polyesters, polyvinyls, polystyrenes, polyurethanes, polycarbonates, including polymers such as ethylene/vinyl alcohol copolymers (EVOH), polyvinylidene chlorides, polyalkylene carbonates, and starch-containing polymers.

The antifog base film may include a single layer or include one or more layers; preferably the antifog base film includes from 2 to 20 layers, more preferably at least 2 layers.

Preferably, the antifog base film includes one or more layers that includes or consists of a component derived at least in part from a polyester. Preferably, some or all of this layer is crystalline to allow for orientation of this layer. Preferably, the base film is an oriented film.

### Heat-Seal Layer

The antifog coated film may include a heat-seal layer—that is, a layer adapted to facilitate the adequate adhesion of the antifog coating to the antifog base film. A preferred heat-seal layer is an amorphous polyester layer made of commonly available copolyester resins that allow for a softer surface for adhesion and enhance surface tension. This heat seal layer, which is part of the base film, enhances the bonding of the antifog coating to the base film. Once produced, this antifog coated film has excellent bonding and sealing affinity to amorphous polyester trays, which normally seal in the 200-300 degree F. range.

The heat seal layer may comprise one or more antifog agents, as well as other additives such as antiblock agents. However, the heat seal layer may be devoid of any or all of such agents.

The thickness of the heat seal layer is selected to provide sufficient material to effect a strong bonding surface for the antifog coating to be deposited. The heat seal layer may have a thickness of from about 0.01 to about 2 mils. Further, the thickness of the heat seal layer as a percentage of the total thickness of the antifog film may be from about 0.025 to about 50 percent.

In some embodiments, the antifog film may include a coextruded polyester film with a polyester base/core layer and an amorphous polyester heat seal layer. The core polyester layer may be a biaxially oriented multilayer polyester. Examples of suitable polyesters include amorphous (co)polyesters, poly(ethylene/terephthalicacid), and poly(ethylene/naphthalate), although poly(ethylene/terephthalic acid) with at least about 75 mole percent, more preferably at least about 80 mole percent, of its mer units derived from terephthalic acid may be preferred for certain applications.

The coextrusion process may include a two- or three-layered compositing die. In general, this multilayer film may be extruded by feeding particles that have been dried (preferably less than 100 ppm moisture content) and feeding them to a melt processor, such as a mixing extruder. The molten material, including the additives, may be extruded through a slot die at about 285° C. and quenched and electrostatically-pinned on a chill roll, whose temperature is about 20° C., in the form of a substantively amorphous prefilm. The film may then be reheated and stretched longitudinally and transversely; or transversely and longitudinally; or longitudinally, transversely, and again longitudinally and/or transversely. The preferred is sequential orientation of first longitudinally, then transversely. It can also be contemplated to orient the film simultaneously in both the longitudinal and transverse dimensions as some film-making processes allow.

The stretching temperatures are generally above the glass transition temperature of the film polymer by about 10 to 60° C.; typical machine direction processing temperature is about 95° C. Preferably, the longitudinal stretching ratio is from 2 to 6 times the original longitudinal dimension, more preferably from 3 to 4.5. Preferably, the transverse stretching ratio is from 2 to 5 times the original transverse dimension, more preferably from 3 to 4.5 with typical transverse direction processing temperature about 110° C. Preferably, any second longitudinal or transverse stretching is carried out at a ratio of from 1.1 to 5 times. The first longitudinal stretching may also be carried out at the same time as the transverse stretching (simultaneous stretching). Heat setting of the film may follow at an oven temperature of about 180 to 260° C., preferably about 220 to 250° C., typically at 230° C., with a 5% relaxation to produce a thermally dimensionally stable film with minimal shrinkage. The film may then be cooled and wound up into roll form.

The amorphous polyester heat seal layer may be an amorphous copolyester skin layer. This amorphous copolyester skin would not be crystalline in nature, having an inherent viscosity (IV) of about 0.4 to 1.2 dL/g. The amorphous copolyester skin layer may have a melting point of less than 210 ° C. The amorphous copolyester skin layer include, for example, isophthalate modified copolyesters, sebacic acid modified copolyesters, diethyleneglycol modified copolyesters, triethyleneglycol modified copolyesters, cyclohexanedimethanol modified copolyesters, or polyethylene 2,5-furanedicarboxylate.

The polyester base film described in this invention will have a section opposite to the coated antifog layer, which we call the outside surface layer. In most cases, that layer is made up of a crystalline polyester resin, which may also comprise the core of our base film. This outside surface layer can be configured to provide a surface upon which a processor can apply a printed image (e.g., printed information), such as by printing ink. As such, the outside layer is preferably configured to be compatible with selected print ink systems.

### Antifog Layer

The antifog film includes at least one antifog layer. The antifog layer contains an effective amount of one or more antifog agents and may be applied to a surface of the heat seal layer. The antifog coating is typically applied to the food side of the film on a surface of the heat seal layer not only to save cost in coating material, but also to avoid coating the non-food side of the film with an agent that may reduce the adhesion of the ink may be printed on the non-food side.

The antifog agent is preferably applied to an amorphous polyester layer of a coextruded polyester film. It has been found that the antifog agent may adhere more strongly to an amorphous polyester layer than to a plain polyester film.

The antifog coating layer may be applied directly on top of the amorphous polyester or heat seal layer, which may be coextruded during the polyester making process. The antifog coating may be applied by known solvent coating techniques, for example, gravure roll, slot die, etc.

Antifog agents known in the art that can be used as a component of the antifog layer fall into classes such as esters of aliphatic alcohols, polyethers, polyhydric alcohols, esters of polyhydric aliphatic alcohols, polyethoxylated aromatic alcohols, nonionic ethoxylates, and hydrophilic fatty acid esters. Specific antifog agents that may be used include polyoxyethylene, sorbitan monostearate, polyoxyethylene sorbitan monolaurate, polyoxyethylene monopalmitate, polyoxyethylene sorbitan tristearate, polyoxyethylene sorbitan trioleate, poly(oxypropylene), polyethoxylated fatty alcohols, polyoxyethylated 4-nonylphenol, polyhydric alcohol, propylene diol, propylene triol, and ethylene diol, monoglyceride esters of vegetable oil or animal fat, mono- and/or diglycerides such as glycerol mono- and dioleate, glyceryl stearate, monophenyl polyethoxylate, and sorbitan monolaurate.

The thickness of the antifog coating layer is selected to provide sufficient material to effect a strong peelable seal to the APET trays. The antifog coating layer may have a weight from about 1 grams per square meter to about 10 grams per square meter, preferably from about 2 grams per square meter to about 6 grams per square meter.

### Barrier Layers

The antifog coated film may include one or more barrier layers between the inside and outside layers. A barrier layer reduces the transmission rate of one or more components—for example, gases or vapors or unreacted monomer—through the antifog coated film. Accordingly, the barrier layer of a film that is made into a package will help to exclude one or more components from the interior of the package—or conversely to maintain one or more gases or vapors within the package.

A gas barrier layer preferably has a thickness and composition sufficient to impart to the antifog coated film an oxygen transmission rate of no more than (in ascending order of preference) 100, 50, 20, 15, and 10 cubic centimeters (at standard temperature and pressure) per square meter per day per 1 atmosphere of oxygen pressure differential measured at 0% relative humidity and 23° C. All references to oxygen transmission rate in this application are measured at these conditions according to ASTM D-3985, which is incorporated herein in its entirety by reference.

Oxygen (i.e., gaseous O2) barrier layers may include one or more of the following polymers: ethylene/vinyl alcohol copolymer (“EVOH”), vinylidene chloride copolymers (“PVDC”), polyalkylene carbonate, polyester (e.g., PET, PEN), polyacrylonitrile, and polyamide. EVOH may have an ethylene content of between about 20% and 40%, preferably between about 25% and 35%, more preferably about 32% by weight. EVOH includes saponified or hydrolyzed ethylene/vinyl acetate copolymers, such as those having a degree of hydrolysis of at least 50%, preferably of at least 85%. A barrier layer that includes PVDC may also include a thermal stabilizer (e.g., a hydrogen chloride scavenger such as epoxidized soybean oil) and a lubricating processing aid (e.g., one or more acrylates). PVDC includes crystalline copolymers, containing vinylidene chloride and one or more other monomers, including for example vinyl chloride, acrylonitrile, vinyl acetate, methyl acrylate, ethyl acrylate, ethyl methacrylate and methyl methacrylate.

A gas barrier layer may also be formed from a latex emulsion coating grade of vinylidene chloride/vinyl chloride copolymer having 5-15% vinyl chloride. The coating grade copolymer of vinylidene chloride/vinyl chloride may be present in an amount of from 5-100% (of total solids) with the remainder being 2-10% epoxy resin and melt extrusion grade material.

The gas barrier layer thickness may range from about (in order of ascending preference) 0.05 to 6 mils (1.27 to 152.4 micrometer), 0.05 to 4 mils (1.27 to 101.6 micrometer), 0.1 to 3 mils (2.54 to 76.2 micrometer), and 0.12 to 2 mils (3.05 to 50.8 micrometer).

The antifog coated film may have any total thickness as long as it provides the desired properties (e.g., flexibility, Young's modulus, optics, seal strength, peelable performance) for a given packaging application of expected use. Useful average thiCknesses for the antifog film include less than about each of the following: 10 mils, 5 mils, 4 mils, 3 mils, 2 mils, 1.5 mils, and 1 mil. (A “mil” is equal to 0.001 inch.) Useful average thicknesses for the antifog coated film also include at least about each of the following: 0.32 mils, 0.5 mils, 0.75 mils, 0.9 mils, 1 mil, and 1.5 mil. The tendency for ghosting appears to increase as the antifog coating thickness decreases.

### Film Additives

One or more layers of the antifog coated film may include one or more additives useful in packaging films, such as, antifog agents, antiblocking agents, slip agents, colorants, pigments, dyes, flavorants, antimicrobial agents, meat preservatives, antioxidants, fillers, radiation stabilizers, and antistatic agents. Such additives, and their effective amounts, are known in the art.

### EXAMPLES

This invention will be better understood with reference to the following examples, which are intended to illustrate specific embodiments within the overall scope of the invention.

Evaluation was made in accordance with the following methods:

### Antifogging Property Test

The antifog effectiveness of an antifog coated film may be assigned a numerical value (“Antifog Rating”) by visually comparing a sample film, which has been exposed to controlled fogging conditions, to reference standards. The controlled fogging conditions are as follows. The sample film is secured over an 8 ounce jar that has about 50% of its internal volume filled with water at room temperature. The sealed jar is allowed to stand at room temperature for an hour to set standard condition. Then the jar is placed in a refrigerator at 45° F. (7° C.). The sealed jar is removed at timed intervals. The exposed sample film is visually assigned an Antifog Rating that most closely resembles the appearance of the exposed sample film.

The Examples herein were tested according to the following protocol. 8 ounce glass jelly jars were used. The jars were 3.5″ tall. The jars were cleaned if already used. The jars were filled to the 2″ level with distilled water and the rim of the jar was wiped free of water. A clicker press was used to cut 4″×4″ pieces of film. The jar was covered with the film with the sealant layer facing the water in the jar. Rubber bands were used to secure the film to the jar (double twisted if needed due to larger size). A flat and tight seal over the jar with no water on the film from the attachment process was ensured. Replicates for each film sample were prepared (three is preferred). The jars were allowed to sit for one hour at room temperature. This becomes the time zero point. Pictures of film at all time points next to the control with no water were taken for reference.

Each of the samples were ranked from 1-8 as follows:
1 is foggy fine drops
2 is very hazy small drops
3 is hazy medium drops
4 is translucent large drops
5 is particularly clear small drops
6 is mostly clear medium drops
7 is clear large drops
8 is clear

The jars were placed into a refrigerator at a temperature from 35F-45F. The temperature was recorded with a thermometer during the test period. Each of the samples were ranked and photographed at the following time intervals: (after each reading the samples were placed back into the refrigerator):
a. Time zero
b. 15 minutes
c. 30 minutes
d. 60 minutes
e. 120 minutes
f. 1440 minutes (24 hours)

### Heat Seal Test:

The antifog coated samples along with other competitive examples were sealed to amorphous polyester trays (coated with denesting fluid) at temperatures between 250 degrees F. and 300 degrees F. (40 psia and 0.5 seconds). The sealed samples were then pulled on a Peel tester using ASTM D-903. All samples were tested for seal strength and ease of peel.

### Examples 1-6

Example 1: A 48 ga polyester film with coextruded seal layer (Toray PA10) was coated with Coim Novacote 8233 at 2.1 grams/sq meter.

Example 2: A 48 ga polyester film with coextruded seal layer (Toray PA10) was coated with Coim Novacote 8233 at 2.5 grams/sq meter.

Example 3: A 48 ga polyester film with coextruded seal layer (Toray PA10) was coated with Coim Novacote 8233 at 2.6 grams/sq meter.

Example 4: A 48 ga polyester film with coextruded seal layer (Toray PA10) was coated with Coim Novacote 8233 at 5.1 grams/sq meter.

Example 5: A 48 ga polyester film with coextruded seal layer (Toray PA10) was coated with Coim Novacote 8233 at 5.9 grams/sq meter

Example 6: A 48 ga polyester film with coextruded seal layer (Toray PA10) was coated with Coim Novacote 8233 at 6.4 grams/sq meter.

### Comparative Examples 1-3

Comparative Example 1: A 92ga polyester film (Toray PA66) was coated with Coim Novacote 8233 at 2.4 grams/sq meter.

Comparative Example 2: Toray's LUMILID® film (118 ga XL5) which is a 36 ga polyester with a thick vinyl acetate coextruded seal layer

Comparative Example 3: Dupont's 100ga OL12AF, which is a sealable antifog coated film.

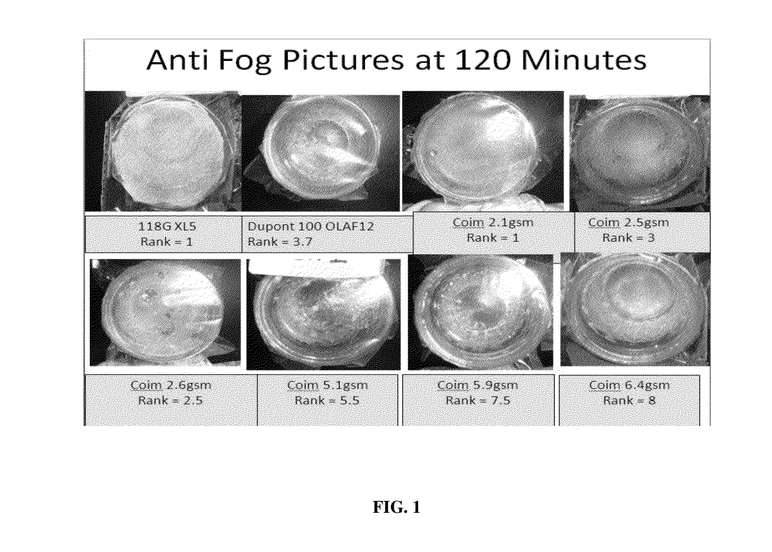

The antifog pictures for the Examples and Comparative Examples at 120 minutes appear in FIG. 1. Table 1 summarizes the results of the testing performed on these examples.

TABLE 1
All lidding samples were sealed to Amorphous polyester trays

| | | | | Antifog |
|---|---|---|---|---|
| | | Seal Strength (at | | rating |
| | Coating bond to | 275 F., 40 psia, | Type of | (1 to 8 |
| | PET film | 0.5 sec) | Peel | (8 = best) |
| Example 1 | Can not separate | 390 gm/inch | Peelable | 1 |
| Example 2 | Can not separate | 480 gm/inch | Peelable | 3 |
| Example 3 | Can not separate | 480 gm/inch | Peelable | 2.5 |
| Example 4 | Can not separate | 525 gm/inch | Peelable | 5.5 |
| Example 5 | Can not separate | 625 gm/inch | Peelable | 7.5 |
| Example 6 | Can not separate | 650 gm/inch | Peelable | 8 |
| Comparative | No Bond | n/a | n/a | n/a |
| Example 1 | | | | |
| Comparative | Can not separate | 90 gm/inch | Peelable | 1 |
| Example 2 | | | | |
| Comparative | Can not separate | 700 gm/inch | Fusion | 3.7 |
| Example 3 | | | | |

Based on the results we can conclude the following:
The antifog coating does not bond to plain polyester film.
Antifog coating bonds to polyester with a heat seal layer acting as primer layer.
The antifog coating performs better at higher coating weights.
The antifog coating when applied to heat sealable polyester, provides a peelable seal to amorphous polyester trays, coated with denesting fluid.

This application discloses several numerical ranges in the text. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A method of making a multilayer antifog film comprising:
coextruding a base layer comprising polyester and a heat seal layer comprising amorphous copolyester; and
applying an antifog coating on a surface of the heat seal layer.

2. The method of claim 1, further comprising biaxially orienting the base layer.

3. The method of claim 2, wherein the base layer is oriented 2 to 6 times in a longitudinal dimension and 2 to 5 times in a transverse dimension.

4. The method of claim 1, wherein the heat seal layer has a thickness of 0.01 to 2 mils.

5. The method of claim 1, wherein the thickness of the heat seal layer is from 0.025 to 50 percent of the thickness of the multilayer film.

6. The method of claim 1, wherein the antifog layer is applied in the range of 1 to 10 gram/sq meter.

7. The method of claim 1, wherein the antifog layer is applied in the range of 2 to 6 grams per square meter.

8. The method of claim 1, wherein the antifog film has a seal strength to amorphous polyester trays in the range of 400 gm/in to 2,000 gm/in, measured at 275 degrees F., 40 psi, 0.5 seconds.

9. The method of claim 1, wherein the antifog film has a seal strength to amorphous polyester trays in the range of 500 gm/in to 1,000 gm/in, measured at 275 degrees F., 40 psi, 0.5 seconds.

10. The method of claim 1, further comprising co-extruding a barrier layer.
